(19) United States
(12) Patent Application Publication
(10) Pub. No.: US 2017/0356111 A1
(43) Pub. Date: Dec. 14, 2017

(54) SEWN FELT COMPOSITE

(71) Applicants: Ivonne Bonatz, Gilching (DE); Wolfgang Bonatz, Gilching (DE)

(72) Inventor: Ivonne Bonatz, Gilching (DE)

(21) Appl. No.: 15/367,817

(22) Filed: Dec. 2, 2016

(30) Foreign Application Priority Data
Jun. 14, 2016 (DE) 10 2016 110 895.2

(51) Int. Cl. D05B 23/00; B32B 7/12; B32B 7/08; B32B 3/16

(52) U.S. Cl. CPC D05B 23/00; B32B 3/16; B32B 7/12; B32B 7/08

(57) ABSTRACT

A felt composite (10) comprises at least one first felt layer (12), a multi-element second felt layer (14) disposed on the first felt layer (12) and comprising at least one first felt form element (16a) and one second felt form element (16b), wherein the first felt form element (16a) has a first edge (20a) and the first felt form element (16a) is sewn up with the first felt layer (12) by means of a first seam (18a) along the first edge (20a), and wherein the second felt form element (16b) has a second edge (20b) running along the first edge (20a) of the first felt form element (16a) and the second felt form element (16b) is sewn up with the first felt layer (12) by means of a second seam (18b) along the second edge (20b).

### REFERENCE TO RELATED APPLICATIONS

This application claims the benefit and filing date of German patent application DE 10 2016 110 895.2 filed Jun. 14, 2016.

### FIELD OF THE INVENTION

The invention relates to a felt composite and a felt cover jointed of a plurality of such felt composites.

### BACKGROUND OF THE INVENTION

As a rule, felt is regarded as a textile composite of irregularly conjoined fibers, which may for example be fabricated by a mechanical treatment of fleeces. A well-known example is wool felt made from sheep wool.

Due to the elasticity and moldability of felt as well its relative thickness compared to woven textiles, there are special requirements when processing felt. Particularly, sewing up large and relatively thin felt layers may pose a challenge.

Several approaches are known for joining a plurality of felt layers. For example, US 2012 225 242 A shows that a felt layer may be sewn and simultaneously glued to a second material layer, which may be felt. FR 2 391 314 A1 shows that mesh patches may be glued to a felt underlay in a mosaic-like fashion and sewn up at the edge.

### ABSTRACT OF THE INVENTION

It is an object of the invention to facilitate the sewing up of a plurality of felt elements to form a composite.

This object is met by the subject-matter of the independent claims. Further embodiments of the invention result from the dependent claims and the following description.

One aspect of the invention relates to a felt composite. Here, a felt composite may be understood as a composition of a plurality of jointed flat felt elements.

According to an embodiment of the invention, the felt composite comprises at least one first felt layer and a multi-element second felt layer disposed on the first felt layer. The two felt layers or felt plies lie flat on top of each another and are joined together by e. g. sewing and/or gluing. Here, the first felt layer may just be one piece, i. e. fabricated as one continuous felt element, while the second felt layer may comprise a plurality of individual felt elements, which may be disposed next to one another, e. g. in a mosaic-like fashion, on the first felt layer. The first felt layer may be a base layer, and the second felt layer may be a top layer.

The felt elements of the second felt layer are formed as felt form elements, wherein the second felt layer comprises at least one first felt form element and at least one second felt form element. Here, a form element may be a felt element having an edge corresponding to a further felt form element so that the two felt form elements may abut each another and/or only a gap remains between the two felt form elements. In particular, the two felt form elements may be of different shapes. Thus, the felt form elements, especially when they are of different colors, may be used to create a pattern in the second felt layer.

The two felt form elements are each sewn up with the first felt layer, wherein the seams run along the edges of the felt form elements. In particular, the first felt form elements has a first edge, wherein the first felt form element is sewn up with the first felt layer by a first seam along the first edge. Correspondingly, the second felt form element has a second edge running along the first edge of the first felt form element or abutting same, wherein the second felt form element is sewn up with the first felt layer by a second seam along the second edge.

In other words, the felt form elements may be sewn up with the first felt layer separate from one another along abutting edges. Particularly, the felt form elements do not have to be directly sewn up with one another. Thus, each felt form element may be sewn to the first felt layer separate from the other felt form elements, which may be of advantage in the case of large felt form elements.

The first seam and the second seam or the seams by which the felt form elements are sewn up with the first felt layer at abutting edges may essentially run parallel. Furthermore, the first seam and the second seam may have a same distance from the associated edge of the respective felt form element.

According to an embodiment of the invention, the seams with which the felt form elements are sewn to the first felt layer, and particularly the first seam and/or the second seam, are machine seams. A machine seam is a seam created by a sewing machine, which as a rule shows regular loops or loops of identical lengths.

According to an embodiment of the invention, the first seam and/or the second seam is a straight stitch seam. A straight stitch seam is created by a straight stitch, backstitch or lockstitch. Here, the sewing machine may create a line of sequential loops out of two intertwined threads.

According to an embodiment of the invention, the felt form elements of the second felt layer and particularly the first felt form element and/or the second felt form element are circumferentially sewn up (by the first and second seams). The first and/or the second felt form element may each be circumferenced by one or more seams so that their edge is completely sewn up with the first felt layer.

According to an embodiment of the invention, the first felt form element and/or the second felt form element are glued to the first felt layer face to face and/or are glued extensively to the first felt layer. Next to the joining of the first felt layer to the second felt layer with a seam, the two felt layers and particularly the felt form elements of the second felt layer may be glued to the first felt layer in order to additionally fix the felt form elements on the first felt layer. In particular, a felt form element may be glued to the first felt layer within the seam and/or between an edge and the associated seam.

According to an embodiment of the invention, the felt form elements of the second felt layer completely cover the first felt layer. The felt form elements of the second felt layer may e. g. be arranged on the first felt layer in a mosaic-like fashion. When the felt form elements are each attached to the first felt layer separately, i. e. each individually by means of seams running essentially parallel on neighboring edges, this may facilitate the sewing up and/or gluing up. It is no longer necessary to position a plurality of felt form elements simultaneously on the first layer, whereby even larger felt form elements may be attached without any distortion.

According to an embodiment of the invention, the felt form elements of the second layer and particularly the first felt form element and the second felt form element are of the same height. In other words, the felt composite may exhibit a planar surface, in particular when the felt form elements of the second felt layer completely cover the first felt layer.

According to an embodiment of the invention, a gap between the first edge and the second edge is less than a height of the form elements of the second felt layer or of the first felt form element and/or the second felt form element. It is possible that the felt form elements of the second layer or their edges, such as the above mentioned first edge and second edge, directly abut. It may, however, also be possible that there is a (relatively narrow) gap between the felt form elements. This gap may have a width of e. g. less than 10% of the height of the form elements of the second felt layer or of the first felt form element and/or the second felt form element.

According to an embodiment of the invention, the second felt layer is sewn up with the first felt layer along a circumferential edge of the felt composite. This edge seam, too, may be a machine seam and particularly a straight stitch seam. The circumferential edge may be formed by edges of the felt form elements of the second layer.

According to an embodiment of the invention, one or both of the felt layers and particularly the felt form elements, i. e. the first felt layer, the first form element and/or the second felt form element, are made of wool felt. Wool felt may be felt made of sheep wool.

As an example, the first layer and the felt form elements of the second layer may be cut out of panels of a felting, particularly a wool felting, and subsequently joined to one another by means of sewing and optionally gluing.

The felt composite may be used individually as a carpet, a curtain or a wall hanging. Felt and in particular wool felt exhibit a sound-absorbing effect, and a felt composite attached to a floor, wall and/or ceiling may have a positive effect on room acoustics.

It is also possible to assemble a plurality of felt composites on a modular basis to form a large-scale cover.

A further aspect of the invention relates to a felt cover assembled of a plurality of felt composites such as described above and below. A felt cover may for example be a carpet, a curtain or a wall hanging.

According to an embodiment of the invention, the felt cover comprises a plurality of felt composites serving as modules of the felt cover as well as a third felt layer to which the felt composites are attached. The felt composites may be glued and/or sewn to the third felt layer adjacently to one another.

As an example, the felt composites may all exhibit the same size (but optionally be of different patterns due to a differing second felt layer). The felt composites may be sewn onto the third felt layer analog to the felt form elements. Thus, the felt cover may have seams connecting the felt form elements of the second felt layer with the first felt layer and further seams extending through all three felt layers and connecting the felt composites with the third felt layer.

It is also possible that the felt cover comprises multi-element felt layers arranged on different levels. In other words, a felt form element of a multi-element felt layer may be arranged on the same level as a (e. g. one-piece) felt layer, a further multi-element felt layer is sewn onto. Here, a level may be understood as the distance of a layer and/or the number of the intermediate layers from an undermost layer.

According to an embodiment of the invention, the felt cover comprises at least one felt composite having a first felt layer and a multi-element second felt layer, such as e. g. described above, and a third felt layer which the at least one felt composite, particularly the first felt layer, is glued and/or sewn onto, a (e. g. multi-element) further felt layer which is arranged adjacent to the felt composite on the third felt layer and which comprises at least one further felt form element, wherein the further felt form element is sewn up with the third felt layer by means of a seam along an edge running along an edge of the felt composite. The felt composite may also be sewn up with the third felt layer along its edge.

In this manner, a pair of seams may be created, which essentially run parallel to each other or next to each other and/or connect the felt form elements to felt layers on different levels of the felt cover. For example, the further felt form element may be sewn directly onto the third felt layer by means of a first seam. Apart from the further felt form element, a felt layer in the form of a basis is sewn onto the third felt layer, on which a felt form element is disposed, which is sewn onto the basis by means of a second seam (for example by means of an additional seam or the same seam). Thus, the further felt form element disposed directly on the third felt layer is on another level than the felt form element on the basis.

The first and the second seam and/or the gap inbetween may be embodied as described above and below with respect to the felt composite. However, the gap may exhibit edges of different heights.

### BRIEF DESCRIPTION OF THE DRAWINGS

In the following, embodiments of the invention are described in detail referring to the attached figures.

FIG. 1 schematically shows a top view of a felt composite according to an embodiment of the invention.

FIG. 2 schematically shows a cross section through a felt composite according to an embodiment of the invention.

FIG. 3 schematically shows a top view of a felt cover according to an embodiment of the invention.

FIG. 4 schematically shows a cross section through a felt cover according to an embodiment of the invention.

FIG. 5 schematically shows a cross section through a felt cover according to a further embodiment of the invention.

The reference signs used in the figures and their meanings are specified in summarizing form in the list of reference signs. As a rule, identical or similar parts are provided with the same reference signs.

### DETAILED DESCRIPTION OF EMBODIMENTS

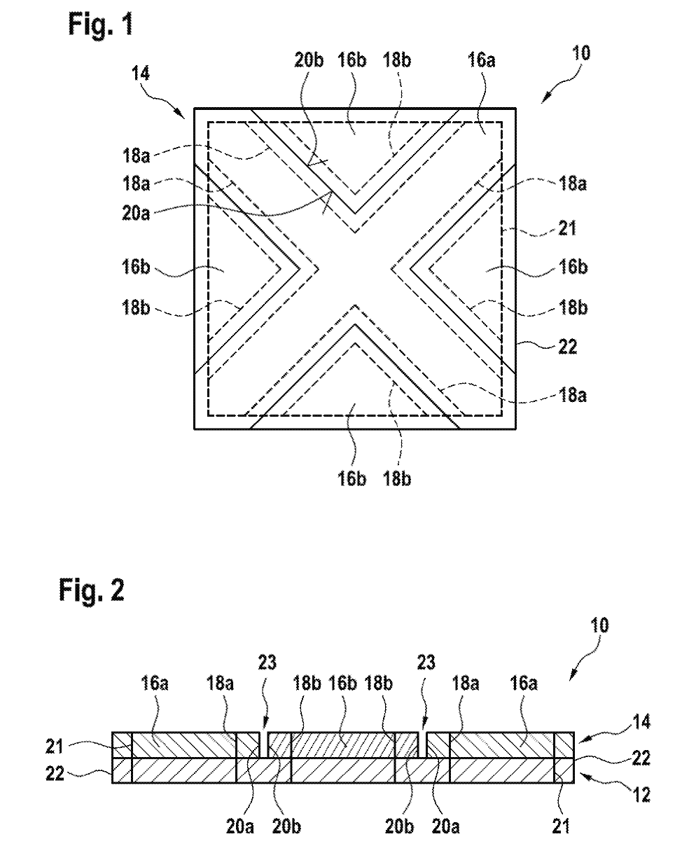

FIGS. 1 and 2 show a felt composite 10 in top view and in cross section. The distances and relations in FIGS. 1 and 2 and the following figures are purely schematic and not true to scale. The felt composite 10 is depicted as a rectangle but may exhibit any outer form such as round, oval, kidney-shaped, etc.

The felt composite 10 comprises a lower, first felt layer 12 which is fabricated in one piece and an upper, second felt layer 14 which is fabricated in a plurality of pieces. In FIG. 1, the top side of the second felt layer 14 is illustrated. The felt composite 10 may for example be a carpet or a carpet module. Here, the lower felt layer 12 serves as the underside of the carpet to be laid on a floor, and the upper felt layer 14 serves as a visible topside to be stepped on.

The upper felt layer 14 comprises a plurality of felt form elements 16a, 16b, which are attached to the lower felt layer 12 in a mosaic-like fashion, covering the same completely. The felt form elements 16a, 16b, which have the same height or thickness, may be of different shapes and/or be fabricated of differently colored felt. In this manner, the felt form elements 16a, 16b are used to create a pattern.

As an example, the first felt layer 12 and the felt form elements 16a, 16b may be cut out of a felting such as bulk stock.

The felt form elements 16a, 16b, which form the upper felt layer 14, are connected to the lower felt layer 12 by means of seams 18a, 18b. As an example, FIG. 1 shows two neighboring seams 18a, 18b running parallel to two neighboring edges 20a, 20b of two felt form elements 16a, 16b. In particular, the felt form elements 16a, 16b are not, in the area of the edges 20a, 20b, fixed to the lower felt layer 12 by means of a common seam but rather separately by means of the two seams 18a, 18b. Thus, the felt form elements 16a, 16b may be sewn to the lower felt layer 12 one after the other, which may facilitate the processing of the felt form elements 16a, 16b.

Furthermore, the felt form elements 16a, 16b are sewn up with the lower felt layer 12 be means of an outer seam 21 which circumferences the felt composite at an outer edge 22. In contrast to the inner seams 18a, 18b, the outer seam 21 is routed across a plurality of felt form elements 16a, 16b. It is, however, also possible that one or more of the inner seams 18a, 18b run across several felt form elements 16a, 16b in several sections.

The seams 18a, 18b, 21 may be executed in the form of machine seams and/or straight stitch seams.

Furthermore, one or more of the felt form elements 16a, 16b may be glued to the lower felt layer 12. In particular, a felt form element 16a, 16b may be glued to the lower felt layer in its inner area within the seams 18a, 18b and/or in an edge area between a seam 18a, 18b and a respective edge 20a, 20b.

For example, the felt composite 10 may be fabricated such that firstly a first felt form element 16a is laid onto the lower felt layer 12, wherein the felt form element 16a may also be provided with glue. Subsequently, the first felt form element 16a may be sewn to the first felt layer 12 by means of one or more inner seams 18a. Furthermore, a second felt form element 16b may be positioned flush against the first felt form element 16a wherein the felt form element 16b may optionally also be provided with glue. After that, the second felt form element 16b may be sewn up with the lower felt layer by means of one or more inner seams 18b. When all felt form elements 16a, 16b have in this manner been sewn up with the lower felt layer, the outer seam 21 may finally be applied.

Eventually, all felt form elements 16a, 16b may be sewn to the lower felt layer 12 by means of one or more seams 18a, 18b, 21 circumferencing them.

As FIG. 2 shows, it is not necessary for the felt form elements 16a, 16b, to directly abut one another by way of their edges 20a, 20b. It is also possible that between the edges 20a, 20b, a gap 23 is created which is, however, relatively narrow and has a width of for example less than 10% of the thickness or height of the second felt layer 14.

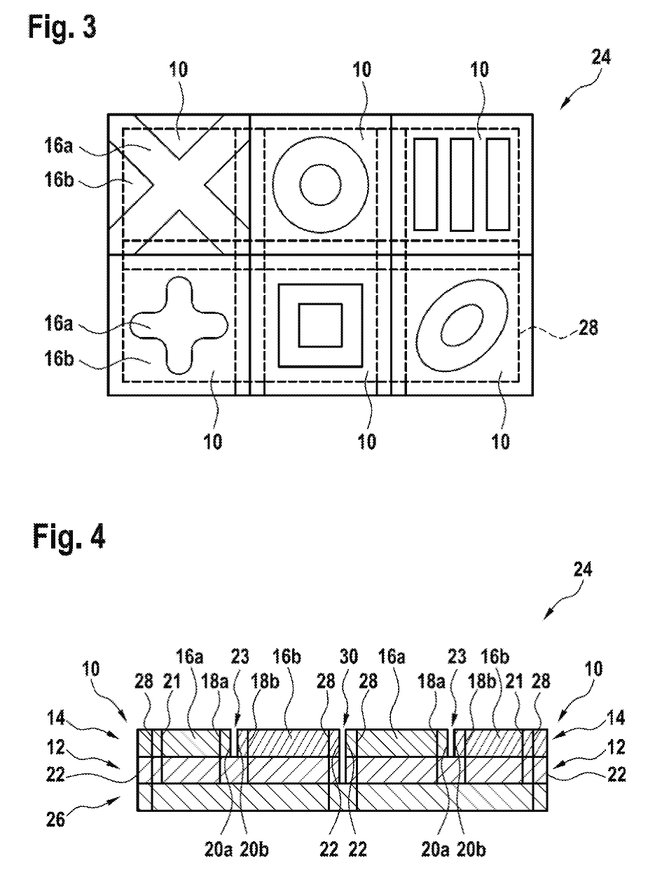

FIG. 3 shows a felt cover 24 which, just like a single felt composite 10, may be a carpet, a wall covering, a ceiling lining, a curtain, etc. The felt cover 24 is assembled of a plurality of felt composites 10 which are arranged flush next to one another.

As an example, the felt composites 10 may all have the same size and/or form and be regarded as modules of the felt cover 24. A square felt composite 10 may for example have a size of 40×40 cm, 60×60 cm or 80×80 cm.

As the felt composites 10 may exhibit different patterns, which may, as described above, be created by the sewing of felt form elements 16a, 16b onto a felt layer 12, the felt cover 24 may be individually collocated.

As FIG. 4 shows, the felt composites 10 may separate from one another be sewn onto a third felt layer 26 which serves as a common supporting layer. This may be effected analog to the felt form elements 16a, 16b which are sewn onto the first felt layer 12. The associated seam 28 here extends through all three felt layers 14, 12, 26.

For example, the one or more seams 28 may circle each one of the felt composites 10 at its respective outer edge 22. In particular, in an area in which two felt composites 10 have edges 22 adjacent to each other, a seam 28 each may run along the respective edge 22.

Furthermore, it is possible that a seam 28 replaces an outer seam 21 and/or runs parallel to an outer seam 21.

Additionally, the felt composites 10 may also be glued onto the felt layer 26.

Between the felt composites 10, too, a gap 30 may be formed which may be relatively narrow. As an example, the gap 30 may exhibit a width less than 10% of the height of one of the felt layers 12, 14, 26. It is however also possible that the felt composites 10 directly abut.

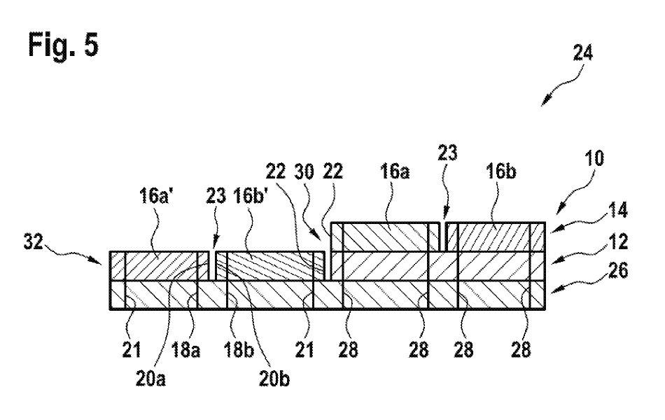

FIG. 5 shows a cross section through a further felt cover 24 on which, analog to FIG. 4, a felt composite 10 is attached e. g. as a module. It is to be understood that the embodiments of FIGS. 4 and 5 may be combined, i. e. that in the embodiment of FIG. 5, a plurality of felt composites 10 may be attached, i. e. glued and/or sewn, to the third felt layer 26.

FIG. 5 also shows that the felt form elements 16a and 16b as well as the first felt layer 12 may be sewn up by seams 28 only, which extend through all three felt layers 14, 12, 26.

FIG. 5 further shows that further felt form elements 16a′ and 16b′ may be directly attached to the third felt layer 26, for example in the same way in which the felt form elements 16a and 16b are sewn and/or glued onto the first felt layer 12 in FIG. 2. The two felt form elements 16a′, 16b′ form a further multi-element felt layer 32.

Here, the felt form element 16b′ is sewn up adjacent to the felt composite 10 so that only a narrow gap 30 remains between the felt form element 16b′ and the felt composite 10. This gap 30 exhibits edges 22 of different heights. It is also possible that the felt form element 16b′ directly abuts the second felt layer 12 of the felt composite 10. Thus, the felt form element 16b′ and the felt form element 16a are now on different levels. Nonetheless, there are two seams 21, 28 running essentially parallel to each other and/or parallel to the adjacent edges 22, by which seams the two felt form elements 16a and 16b′ are connected to the third felt layer 26 separately from each other. In particular, the felt form elements 16a, 16b′ are, in this area, fixed to the third felt layer 26 not by a common seam but separate from each other by the two seams 21, 28.

Complementary, it is to be pointed out that “comprising” does not exclude any other elements or steps and “one” does not exclude any multiplicity. It is further to be pointed out that features or steps described with reference to one of the above embodiments may also be used in combination with other features or steps of other embodiments described above. Reference signs in the claims are not to be understood as in any way limiting.

### LIST OF REFERENCE SIGNS

10 felt composite
12 first felt layer
14 second felt layer
16a first felt form element
16b second felt form element
16a′ further felt form element
16b′ further felt form element
18a first seam
18b second seam
20a first edge
20b second edge
21 outer seam
22 outer edge
23 gap
24 felt cover
26 third felt layer
28 seam
30 gap
32 further felt layer

1. A felt composite, comprising:
at least one first felt layer;
a multi-element second felt layer disposed on the first felt layer and comprising at least one first felt form element and at least one second felt form element, which are disposed next to one another on the first felt layer;
wherein the first felt form element and the second felt form element are sewn up with the first felt layer separate from one another along abutting edges;
wherein the first felt form element has a first edge and the first felt form element is sewn up with the first felt layer by means of a first seam along the first edge;
wherein the second felt form element has a second edge running along and abutting the first edge of the first felt form element and the second felt form element is sewn up with the first felt layer by means of a second seam along the second edge.

2. The felt composite of claim 1,
wherein at least one of the first seam and the second seam is a machine seam.

3. The felt composite of claim 1,
wherein at least one of the first seam and the second seam is a straight stitch seam.

4. The felt composite of claim 1,
wherein at least one of the first felt form element and the second felt form element is circumferentially sewn up with the first felt layer by means of a seam.

5. The felt composite of claim 1,
wherein at least one of the first felt form element and the second felt form element are glued to the first felt layer.

6. The felt composite of claim 1,
wherein the felt form elements of the second felt layer completely cover the first felt layer.

7. The felt composite of claim 1,
wherein first felt form element and the second felt form element have the same height.

8. The felt composite of claim 1,
wherein the first felt layer, the first felt form element and the second felt form element are made of wool felt.

9. The felt composite of claim 1,
wherein a gap between the first edge and the second edge is less than a height of at least one of the first felt form element and the second felt form element.

10. The felt composite of claim 1,
wherein the first edge and the second edge abut.

11. The felt composite of claim 1,
wherein the second felt layer is sewn up with the first felt layer along a circumferential edge of the felt composite.

12. A felt cover, comprising:
a plurality of felt composites as modules of the felt cover; and
a third felt layer;
wherein each of the felt composites comprises at least one first felt layer and a multi-element second felt layer disposed on the first felt layer and comprising at least one first felt form element and at least one second felt form element, which are disposed next to one another on the first felt layer;
wherein the first felt form element and the second felt form element are sewn up with the first felt layer separate from one another along abutting edges;
wherein the first felt form element has a first edge and the first felt form element is sewn up with the first felt layer by means of a first seam along the first edge;
wherein the second felt form element has a second edge running along and abutting the first edge of the first felt form element and the second felt form element is sewn up with the first felt layer by means of a second seam along the second edge;
wherein the felt composites are at least one of glued and sewn onto the third felt layer adjacently to one another.

13. The felt cover of claim 12,
wherein at least one of the first felt form element and the second felt form element is circumferentially sewn up with the first felt layer by means of a seam.

14. The felt cover of claim 12,
wherein at least one of the first felt form element and the second felt form element are glued to the first felt layer.

15. The felt cover of claim 12,
wherein the second felt layer is sewn up with the first felt layer along a circumferential edge of at least some of the felt composites.

16. A felt cover, comprising:
at least one felt composite;
a third felt layer onto which the at least one felt composite is at least one of glued and sewn;
a further felt layer;
wherein each of the felt composites comprises at least one first felt layer and a multi-element second felt layer disposed on the first felt layer and comprising at least one first felt form element and at least one second felt form element, which are disposed next to one another on the first felt layer;
wherein the first felt form element and the second felt form element are sewn up with the first felt layer separate from one another along abutting edges;
wherein the first felt form element has a first edge and the first felt form element is sewn up with the first felt layer by means of a first seam along the first edge;
wherein the second felt form element has a second edge running along and abutting the first edge of the first felt form element and the second felt form element is sewn up with the first felt layer by means of a second seam along the second edge;
wherein the further felt layer is disposed on the third felt layer adjacently to the felt composite and comprising at least one further felt form element;
wherein the further felt form element is sewn up with the third felt layer by means of a seam along an edge running along an edge of the felt composite.

17. The felt cover of claim 16,
wherein at least one of the first felt form element and the second felt form element is circumferentially sewn up with the first felt layer by means of a seam.

18. The felt cover of claim 16,
wherein at least one of the first felt form element and the second felt form element are glued to the first felt layer.

19. The felt cover of claim 16,
wherein the second felt layer is sewn up with the first felt layer along a circumferential edge of the felt composite.
